(19) United States
(12) Patent Application Publication
(10) Pub. No.: US 2005/0236533 A1
(43) Pub. Date: Oct. 27, 2005

(54) Height adjustable stand for LCD monitor with detachment and lockdown features

(75) Inventors: William C. McRight, Round Rock, TX (US); David M. Combs, Pflugerville, TX (US)

Correspondence Address: HAMILTON & TERRILE, LLP, P.O. BOX 203518, AUSTIN, TX, 78720, US

(73) Assignee: Dell Products L.P., Round Rock, TX (US)

(21) Appl. No.: 10/832,736

(22) Filed: Apr. 27, 2004

(51) Int. Cl. F16M 11/00; H04L 12/28

(52) U.S. Cl. 248/161; 248/917

(57) ABSTRACT

An information handling system support stand is provided for a peripheral device, such as an LCD monitor. A lockdown feature is included for fixing the height of the stand in a full-down position and a release feature is included for detaching the LCD monitor from the support stand by actuating a push button.

### BACKGROUND OF THE INVENTION

1. Field of the Invention

The present invention relates in general to the field of information handling peripheral devices. In one aspect, the present invention relates to an adjustable stand for an LCD monitor.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are well known in the art, and include examples such as personal computers, servers, laptop computer with docking stations, and other computer systems. Information handling systems in general, and Dell computer systems in particular, have attained widespread use throughout the world in providing computing products for a wide range of personal and business needs. A personal computer system can typically be defined as a desktop, floor standing, or a portable microcomputer that is comprised of a system unit having one or more central processing units (CPU) and associated volatile and non-volatile memory, including random access memory (RAM) and Basic Input Output System (BIOS) memory. Typically, a personal computer system also includes additional system and/or peripheral devices to display, print, communicate or otherwise process information. For instance, displays (also known as a “video display terminal” or “system monitor”), speakers, printers, video display controllers, keyboards, pointer devices, scanners and network cables are included in or connected to an information handling system to communicate information and in some cases power from the information handling system to each peripheral.

Often, system and/or peripheral devices are positioned during set up of the information handling systems to remain in a relatively permanent position. In large part, the relatively fixed position of system and/or peripheral devices has resulted from the bulkiness and weight of information handling systems and peripherals, which has restricted the practicality of rearrangement of a set-up system. As an example, conventional cathode ray tube (CRT) displays generally have such large footprints and weights that movement of a CRT display in a desktop environment is not practical. This has become increasingly true as consumers have moved towards larger CRT displays having greater display space.

Recently, as the power of information handling system components has increased and their sized decreased, information handling system and peripheral component manufacturers have strived to reduce the size of installed systems and thus improve consumer flexibility in arranging a system. One innovation that has helped to reduce the footprint of installed information handling systems is the use of flat panel displays instead of CRT displays. Flat panel displays use liquid crystal display (LCD) or plasma pixels to display information instead of phosphors pixels used by CRT displays and thus do not require an electron gun to illuminate the pixels. As a result, flat panel displays have considerably reduced depth and weight when compared with CRT displays. The reduced bulkiness and weight of flat panel displays allows information handling system users to more easily adjust the position of a display on a desktop. In addition, flat panel displays are often mounted on a stand that allows rotation of the display, both vertically and horizontally, and adjustment of the height of the display area relative to the desktop. Typically, the stands use a spring or coil-type mechanism to control the height position of the display, where the spring or coil-type mechanism is designed to offset the weight of the display so that the display can be placed at a desired height when the stand and display are resting on a horizontal surface, such as a desktop. However, one difficulty that often arises with movement of a display stand is that the spring or coil-type mechanism in the stand causes the stand to open or extend to its full height or length. This can make handling of a display awkward and unwieldy. In addition, the extended height position can add additional expense and complications when shipping or moving a display.

An additional challenge associated with conventional display stand configurations is that the LCD monitors are typically attached fixedly attached to a stand with screws or similar fixture mechanisms in accordance with Video Electronics Standards Association (VESA) standards for displays and display interfaces. Such conventional attachment mechanisms make the removal of a display from its stand unnecessarily difficult and complex, requiring the use of a screwdriver or other tooling to detach the monitor from the stand. This can make it difficult to remove an LCD display from its stand for special mounting applications, and can also add additional expense and complications when shipping or moving a display.

Therefore, a need exists for methods and/or apparatuses for improving the placement, positioning and connection of information handling system peripheral devices. In addition, a need exists for positioning and connecting an information handling system peripheral device to support convenient movement of the information handling system peripheral, such as movement of a flat panel display in a desktop environment. Further limitations and disadvantages of conventional systems will become apparent to one of skill in the art after reviewing the remainder of the present application with reference to the drawings and detailed description which follow.

### SUMMARY OF THE INVENTION

In accordance with the present invention, a system and method are provided which substantially reduce the disadvantages and problems associated with previous information handling system peripheral support stands. In selected embodiments, a locking mechanism disposed in the peripheral stand locks the stand in a predetermined position so that the stand does not open or extend when lifted or when the peripheral device is removed from the stand, and a push-button releases the stand for height adjustment. The locking mechanism may be a plate, die cast mold member or other engagement device for releasably latching or engaging with the support stand when the stand is in the full-down position. For example, internal cables or structural members in a height extender portion of the stand may be engaged by the locking mechanism when the height extender portion is lowered or otherwise placed in a predetermined position.

In other embodiments, the stand is releasably attached to the peripheral device using a push-button detachment mechanism. In selected embodiments, a detachment mechanism on the peripheral stand releasably attaches the stand to the peripheral device so that the peripheral device may be securely fixed to the stand and also easily removed using a push-button release mechanism. The detachment mechanism may be implemented with a detachment plate (that is affixed to the stand) and a releasable connector (that is affixed to the peripheral device). For example, the releasable connector may include a plate, die cast mold member or other engagement device for releasably latching or engaging with the detachment plate.

The objects, advantages and other novel features of the present invention will be apparent from the following detailed description when read in conjunction with the appended claims and attached drawings.

### BRIEF DESCRIPTION OF THE DRAWINGS

FIG. 1 depicts a rear view of an information handling system flat panel display in accordance with selected embodiments of the present invention;

FIGS. 2a-d depict a close-up rear and side view of an exemplary detachment mechanism in accordance with selected embodiments of the present invention;

FIG. 3 depicts a close-up perspective view of a detachable latch in accordance with selected embodiments of the present invention;

FIGS. 4a-e depict a close-up side, rear and perspective view of an exemplary lockdown latch mechanism in accordance with selected embodiments of the present invention;

FIG. 5a-c depict a close-up side and plan view of an alternative exemplary lockdown latch mechanism in accordance with selected embodiments of the present invention; and

FIG. 6 depicts an exemplary implementation of a lockdown mechanism in a flat panel display system.

### DETAILED DESCRIPTION

A method and apparatus for improved peripheral stand with detachment and/or lockdown features is described in connection with an exemplary information handling system. While various details are set forth in the following description, it will be appreciated that the present invention may be practiced without these specific details. For example, selected aspects are shown in block diagram form, rather than in detail, in order to avoid obscuring the present invention. Such descriptions and representations are used by those skilled in the art to describe and convey the substance of their work to others skilled in the art. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, servers, laptop computer with docking stations, a network storage device, or any other suitable computer system or device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

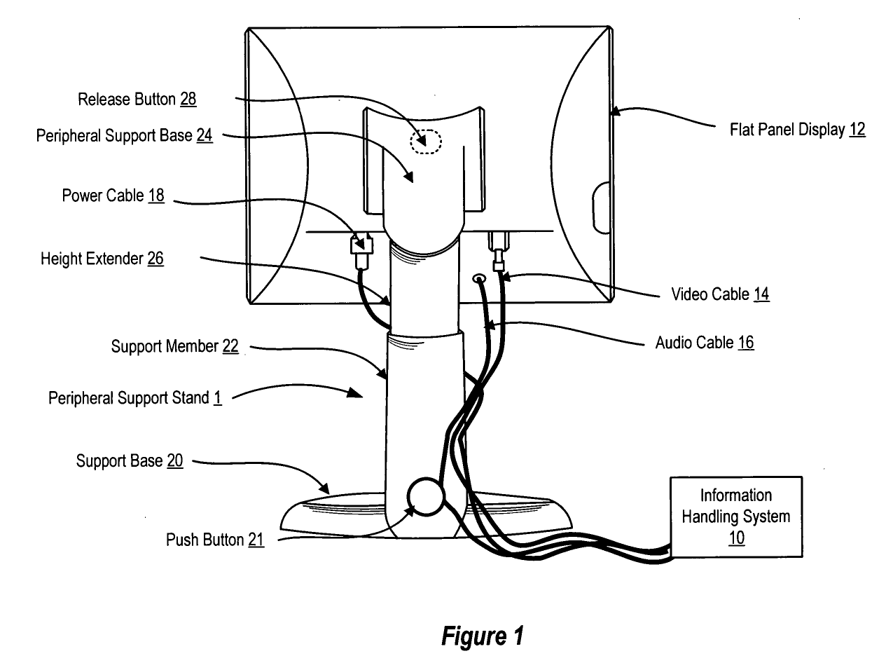

Referring now to FIG. 1, an adjustable and detachable support 1 is depicted as being connected to an information handling system 10 and a peripheral device, such as a display monitor, television, LCD display or flat panel display 12. Information handling system 10 includes processing components, such as a CPU, video card and audio card, which generate information for presentation at flat panel display 12. Graphic and/or video information is communicated from information handling system 10 to flat panel display 12 through a video cable 14 for presentation at a display screen. Audio information is communicated from information handling system 10 to flat panel display 12 through an audio cable 16 for presentation at integrated speakers. A power cable 18 provides power from information handling system 10 to power flat panel display 12.

Flat panel display 12 is supported in a viewing position by an adjustable and detachable support stand 1 that is separate from information handling system 10. The adjustable and detachable support stand 1 is depicted as including a support stand base 20, support member 22, and peripheral support base 24. The support base rests on a flat surface, such as a desktop, to provide a stable platform. In addition, the support base includes a stand lock (described below) which is actuated by a push button or other release actuator 21. In accordance with various embodiments of the present invention, push button 21 is used to lock the support stand 1 in a predetermined position (e.g., full-down position). Upon actuation of push button 21, the stand is released for height adjustment, such as by raising the stand height extension member 26. This allows easy handling when installing or relocating the display 12.

Adjustable support member 22 couples to support base 20 at a bottom end and couples to an adjustable peripheral support base 24 at a top end via stand height extension member 26. Peripheral support base 24 couples to flat panel display 12 to hold flat panel display 12 in a viewing position selected by a user. Support member 22, stand height extension member 26 and peripheral support base 24 cooperate to adjust along a vertical axis to raise and lower flat panel display 12, to rotate about the vertical axis to change the viewing angle relative to support stand base 20, and to rotate about a horizontal axis to change the view between a landscape and portrait view.

To assist with movement of flat panel display 12 about the vertical and rotational axes, the peripheral support base 24 must be securely affixed to the display 12, especially when a user is gripping the display 12 to make positional adjustments. However, a selected embodiment of the present invention provides a detachment mechanism for releaseably connecting the peripheral support base 24 to the display 12. For example and as described more fully below, the peripheral support base 24 may include a detachment plate that engages with a connection mechanism on the exterior housing for the display 12, and that is disengaged upon actuation of a release button or other release actuator 28 (which may be located on the back of the monitor). In accordance with various embodiments of the present invention, release button 28 is used to detach the display 12 from the adjustable and detachable support 1, thereby allowing the stand to be shipped separately for reduced shipping damage and/or cost. In addition, the detachment mechanism allows the customer to easily detach the stand for special mounting applications, such as wall mounting of the display 12. As will be appreciated, pushbutton 21 and 28 can push in, push out, rotate in any direction and/or slide sideways.

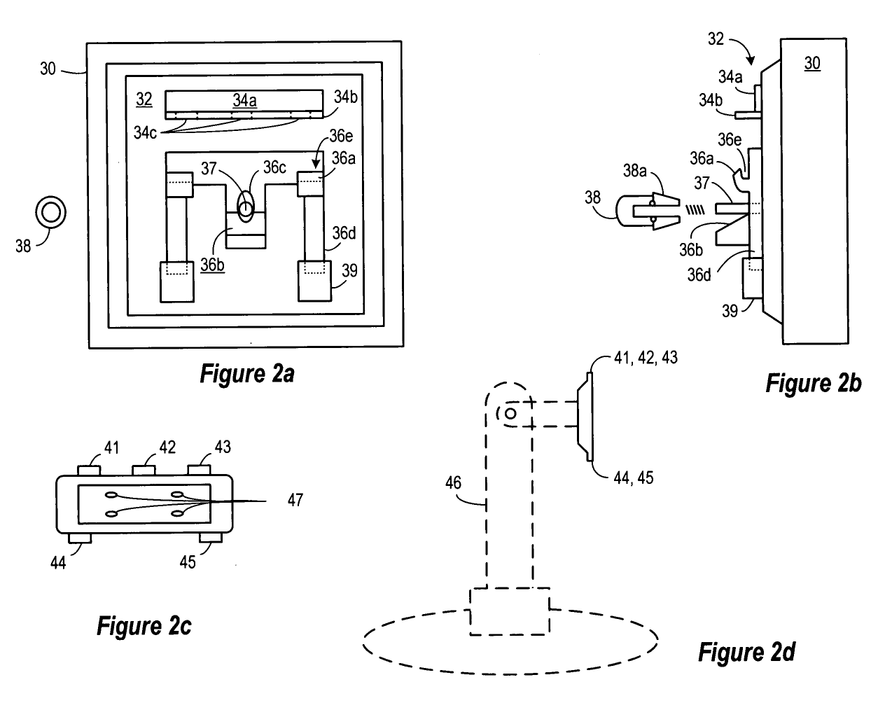

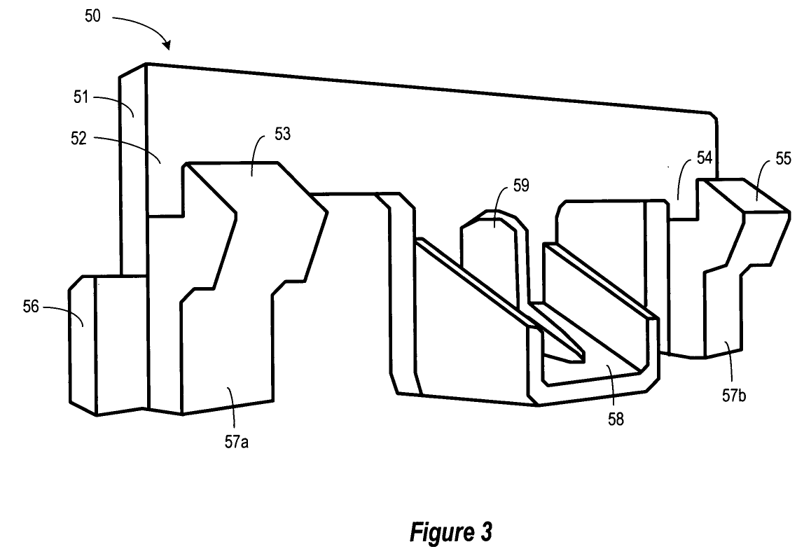

Referring now to FIGS. 2a-2d, an illustrative embodiment of a detachment mechanism in accordance with the present invention is illustrated with reference to a back and side view, respectively, of a connection mechanism 32 and detachment plate 40. As illustrated in FIGS. 2a and 2b, the back exterior housing for a peripheral device 30 includes a connection mechanism 32 for releasable engagement with a detachment plate which (as shown in FIGS. 2c and 2d) may be fixedly attached to the support stand 46.

In particular and as illustrated in FIGS. 2a and 2b with the back and side views of peripheral device 30, a connection mechanism 32 may be constructed with one or more tab receptacles, holes or slots for receiving one or more tabs (e.g., 41, 42, 43) from the detachment plate 40 (illustrated in FIG. 2c). For example, a tab receptacle 34 may be constructed of one or more openings 34c formed in an upper connection member 34b that is affixed directly or indirectly to the peripheral device 30, such as by way of welding to a first mount member 34a that is affixed to the peripheral device by fasteners, screws, welding or the like. To permit the releasable detachment of detachment plate 40, the connection mechanism 32 may also be constructed with a movable latch 36 that may be moved up and down by actuation of the release button or other release actuator 38. For example, the movable latch may be attached to the peripheral device 30 for slidable movement up and down so that it is normally in the “up” position, such as by positioning the movable latch within a recess in the peripheral housing with guidance arms 36d in sleeves 39 under control of a spring or other tension arrangement (not shown) within the sleeves. As a result, when the slanted surface 38a of the release button 38 is pushed against the slanted surface 36b of the movable latch 36, the latch 36 is pushed down and guided by the guidance arms 36d as they move through sleeves 39 and by the opening 36c through which post 37 and/or release button 38 pass. Through the downward movement of latch 36, one or more tab receptacles, holes or slots 36e formed by tab(s) 36a are positioned to receive one or more tabs (e.g., 44, 45) from the detachment plate 40 (illustrated in FIG. 2c). Once the release button 38 is deactuated, the spring 39 pushes the button 38 back, thereby permitting the latch 36 to return to its normally “up” position to securely engage the tab(s) from the detachment plate. As will be appreciated, the movable latch may be constructed with any design, shape, structure and/or material, but in accordance with a selected embodiment, the movable latch may be constructed of die cast metal (e.g., zinc or steel) or using metal stamp techniques or any available molding technique. In addition, though the positioning and movement of the latch in relation to the peripheral device is illustrated in connection with guidance arms 36d, sleeves 39, post 37 and opening 37, it will be appreciated that other approaches may be used to like effect, such as by using grooves, rollers, bearings and the like. As will be appreciated, the movable latch may be operative to move in any direction (e.g., up, down or side to side) or to rotate and/or slide sideways or to otherwise disengage with the plate.

Referring now to FIGS. 2c and 2d with the back and side views of detachment plate 40, the detachment plate 40 is affixed directly or indirectly to the stand 46 (indicated in dashed lines in FIG. 2d) by fasteners, screws, welding or the like. As illustrated, the detachment plate 40 may be constructed with one or more tabs, extensions, hooks, or other engagement members (e.g., 41-45) for engagement with the receptacles, holes or slots 34c, 36e in the connection mechanism 32 (illustrated in FIGS. 2a, b). To releasably engage the plate 40 with the connector 32, the upper tabs 41, 42, 43 may be inserted into upper tab openings 34c, and as the lower tabs 44, 45 engage with the slanted surface of tab(s) 36a, the moveable latch 36 moves down so that the lower tabs may engage with the slot(s) 36e. Once in place, the moveable latch 36 returns to its normally “up” position, thereby securing the detachment plate 40 and stand 46 to the peripheral device 30. As will be appreciated, the detachment plate may be constructed with any design, shape, structure and/or material, but in accordance with a selected embodiment, the detachment plate may be constructed of die cast metal (e.g., zinc or steel) or using metal stamp techniques or any available molding technique. As shown in FIG. 2c, the detachment plate 40 may include one or more screw openings 47 that are spaced in compliance with one or more VESA-compliant standards for defining the mounting interfaces, hole patterns and associated cable/power supply locations for LCD monitors, plasma displays and other flat panel devices, including but not limited to the VESA MIS-D, MIS-E, MIS-F standards.

Referring now to FIG. 3, a perspective view is illustrated of a latch piece 50, such as may be used with connection mechanism 32. As depicted, latch 50 may be constructed as a die cast piece or a molded piece. However, constructed, the latch piece 50 includes a back panel 51, side tabs 56, engagement tabs 53, 55, push-button engagement surface 58, opening 59 and guide arm(s) 57a, 57b. The latch piece 50 may be slidably engaged as part of the connection mechanism by positioning the side tab(s) 56 and/or guide arm(s) 57a, 57b in a guide sleeve (not shown) and/or by positioning the opening 59 about a latch post (e.g., post 37 shown in FIG. 2b). The push-button engagement surface 58 engages with a slanted surface of a push-button (not shown) to slide the latch piece 50 down when the push-button is actuated. The opening 59 permits the latch piece 50 to move up and down about a latch post. When the latch piece 50 is down, a detachment plate tab (not shown) that is engaged in the slot(s) 52, 54 formed by engagement tabs 53, 55 may be removed or disengaged. In similar fashion, the detachment plate tab(s) may be moved into engagement with the latch piece 50 when the detachment plate tab(s) engage with the slanted surface of the engagement tabs 53, 55, which causes the latch piece 50 to move down so that the detachment plate tab(s) fit into slot(s) 52, 54. As will be appreciated, the latch piece may be operative to move in any direction (e.g., up, down or side to side) or to rotate and/or slide sideways or to otherwise disengage with the plate.

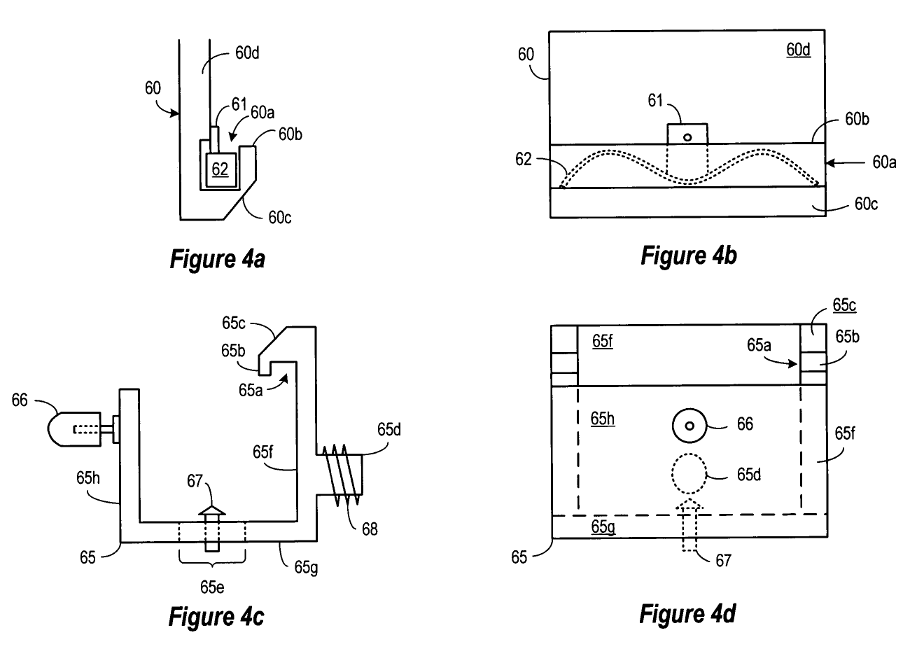

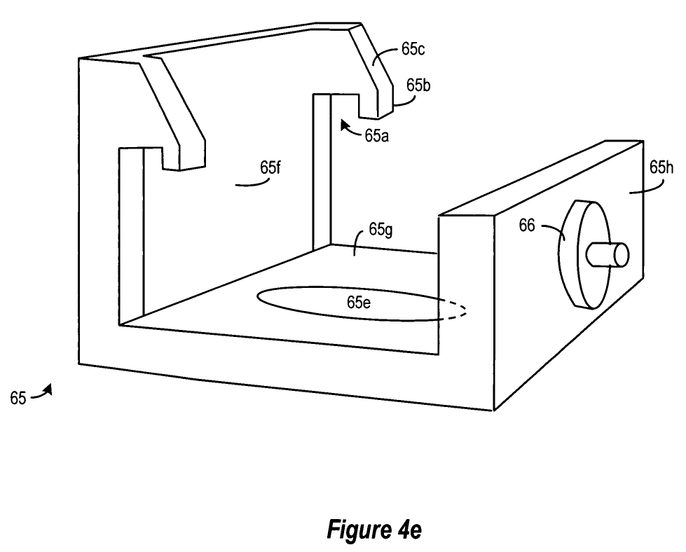

Referring now to FIGS. 4a-4e, an illustrative embodiment of a lockdown mechanism in accordance with the present invention is depicted with reference to a side and front view, respectively, of an exemplary position member 60 and lock piece 65. As illustrated in FIGS. 4a and 4b, the peripheral stand may include a position member 60 for releasable engagement with a lock piece 65 (as shown in FIGS. 4c and 4d) which may be fixedly attached to the support stand 1. For example, the lock piece 65 may be included in the support member 22 and positioned to receive and engage with a position member component of height extension member (e.g., height extender 26 shown in FIG. 1). Though depicted herein as a slideably engaged piece, it will be appreciated the lock piece may slide, rotate or otherwise move out of engagement with the position member.

In particular and as illustrated in FIGS. 4a and 4b with the side and front views of position member 60, the position member 60 may be constructed with one or more tab receptacles, holes, slots or openings 60a for engagement with the lock piece 65 (illustrated in FIGS. 4c-4d). As illustrated and described herein, the opening 60a may also contain a spring or coil device 62 which is affixed to the position member 60 by connector 61. This spring or coil device 62 contributes a downward force on the position member 60 when engaged with the lock piece 65, and at the same time exerts an upward force on the lock piece tab 65b when engaged within the opening 60a. In addition, the position member 60 includes a height extension member 60d, which may be formed of or connected to internal cables or structural member components in the stand 1, such as the height extension member 26. To permit the engagement of the position member 60 with the lock piece 65, the position member, which moves up and down as the position of the peripheral device is adjusted, includes a slanted surface 60c to facilitate locking engagement of the position element 60 with the lock piece 65. Once engaged, the sidewall 60b prevents the lock piece 65 (and in particular, lock piece tab 65b) from sliding horizontally to disengage unless the position member 60 is manually pushed “down” in relation to the lock piece 65, such as when the customer pushes down on the peripheral device.

Referring now to FIGS. 4c and 4d with the side and front views, a lock piece 65 is illustrated, such as may be used with lockdown mechanism. In addition, FIG. 4e depicts a perspective view lock piece 65. As will be appreciated, lock piece 65 may be constructed with any design, shape, structure and/or material, but in accordance with a selected embodiment, the lock piece 65 may be constructed as a stamped, die cast or molded piece. However constructed, the lock piece 65 includes a front panel 65h, base plate 65g (in which is formed slot opening 65e for passage of fixture screw 67), back panel 65f, spring post 65d, slanted surface 65c and lock piece tab 65b which forms a slot or opening 65a. Lock piece 65 is movably affixed to the stand by fixture screw 67 (or like device) through opening or slot 65e (indicated in dashed lines in FIG. 4c) formed in the base plate 65g of lock piece 65. For example, fixture screw 67 may engage with the support base of adjustable and detachable support stand 1. As illustrated, the lock piece 65 may be moved back and forth in the horizontal plane by actuation of push-button or other actuator 66 against the spring or coil 68 that is positioned around spring post 65d. For example, the lock piece 65 may be attached to the support stand for slidable movement to the left and right so that it is normally in the “left” position unless actuated by push-button 66 to move to the “right” position. As a result, when the slanted surface 60c of position member 60 pushes down against slanted surface 65c of the lock piece 65, the lock piece 65 is pushed to the right against spring 68. Once the sidewall 60b is below the lock piece tab 65b, spring 68 returns the lock piece 65 to its normally “left” position, thereby engaging the position member 60 into a lockdown position. To unlock the position member 60, the position member is pushed down and the push-button is actuated or pushed to the right, thereby permitting the position member to be raised, either manually or in response to a coil or spring component in the stand (not shown). With this configuration, the position member will not be accidentally released with actuation of the push-button unless the customer is prepared to control the lifting action of the coil or spring component in the stand (not shown).

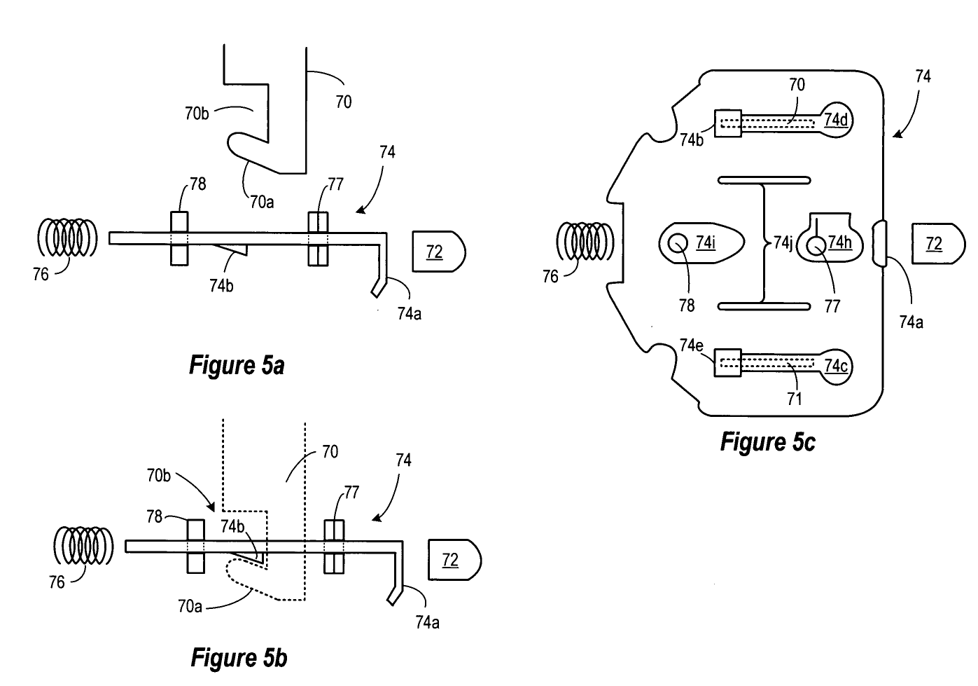

Referring now to FIGS. 5a-5c, an alternate illustrative embodiment of a lockdown mechanism in accordance with the present invention is depicted with reference to a side and plan view, respectively, of an exemplary support extension member 70 and locking plate 74. As illustrated in FIGS. 5a and 5b, the peripheral stand may include a support extension member 70 for releasable engagement with a locking plate 74 (illustrated in plan view in FIG. 5c) which may be fixedly attached to the support stand 1. For example, the lock plate 74 may be fastened at the bottom of the support member 22 and positioned to receive and engage with a component of height extension member (e.g., height extender 26 shown in FIG. 1).

In particular and as illustrated in FIGS. 5a and 5b, support extension member 70 is depicted as being disengaged (FIG. 5a) and engaged (FIG. 5b) with lock plate 74. In the disengaged position (such as occurs when the height extender 26 is raised) is not engaged with the lock plate 74, and the lock plate is maintained in a preferred position by the spring or coil device 76. By proper placement of the support extension member 70 in relation to the receiving slot(s) (e.g., opening 74c), the support extension member 70 may be prevented from entering into locking engagement with the lock plate 74 unless the push-button 72 is actuated to press against the lock plate tab 74a, thereby moving the lock plate to the left to align the receiving slot(s) and the support extension member 70. Thus aligned, the support extension member(s) 70 may be lowered through the receiving slot(s) so that, when the lock plate returns to its preferred position under control of the spring or coil device 76, the support extension member 70 is positioned for locking engagement with the lock plate 74, as depicted in FIG. 5b. Once engaged, unintentional disengagement is prevented by including a slide tab 74b on the lock plate 74. For example, by providing a slanted surface 74b on the lock plate 74 for engagement with an opening in the support extension member 70, the lock plate 74 may not be disengaged by actuation of the push-button 72 unless there is also a lowering of the support extension member 70.

As illustrated in the plan view of FIG. 5c, the lock plate 74 may be constructed with one or more tab receptacles, holes, slots or openings 74c, 74d for engagement with one or more support extension members 71, 70 (indicated with dashed lines as being inserted through the openings 74c, 74d and engaged with slide tabs 74b, 74e). Additional tab receptacles, holes, slots or openings may be provided for guiding and controlling the movement of the lock plate 74. For example, openings 74h, 74i receive guide posts or screws 77, 78, thereby permitting lock plate to move in response to the push-button 72 and spring or coil device 76. In this way, lock plate 74 is movably affixed to the stand by fixture screws 77, 78 (or like device) through opening or slots 74h, 74i formed in the lock plate 74. For example, fixture screw 77 may engage with the support base of adjustable and detachable support stand 1. Additional grooves or slots 74j may also be used to slidably engage the lock plate 74 with other componentry in the support base (not shown).

As illustrated in FIG. 5c, the spring or coil device 76 maintains the lock plate 74 in a preferred position, and actuation of the button 72 pushes against the lock plate tab 74a to displace the lock plate from its preferred position. As a result, when the push-button 72 pushes down against lock plate tab 74a, the lock plate 74 is pushed against spring 76. Once the slots or openings 74c, 74d are properly aligned, the support extension member 70 slides into engagement with the openings 74c, 74d, thereby engaging the support extension member 70 into a lockdown position. To unlock the support extension member 70, the support extension member 70 is pushed down and the push-button 72 is actuated or pushed, thereby permitting the support extension member 70 to be raised, either manually or in response to a coil or spring component in the stand (not shown). With this configuration, the support extension will not be accidentally released with actuation of the push-button unless the customer is prepared to control the lifting action of the coil or spring component in the stand (not shown).

As will be appreciated from the depiction in FIGS. 5a-b, lock plate 74 may be constructed as a die cast piece or a molded piece, but is advantageously formed as a stamped metal piece. By using a metal stamp, the locking mechanism is efficiently manufactured and may be shaped to fit into the adjustable and detachable support stand.

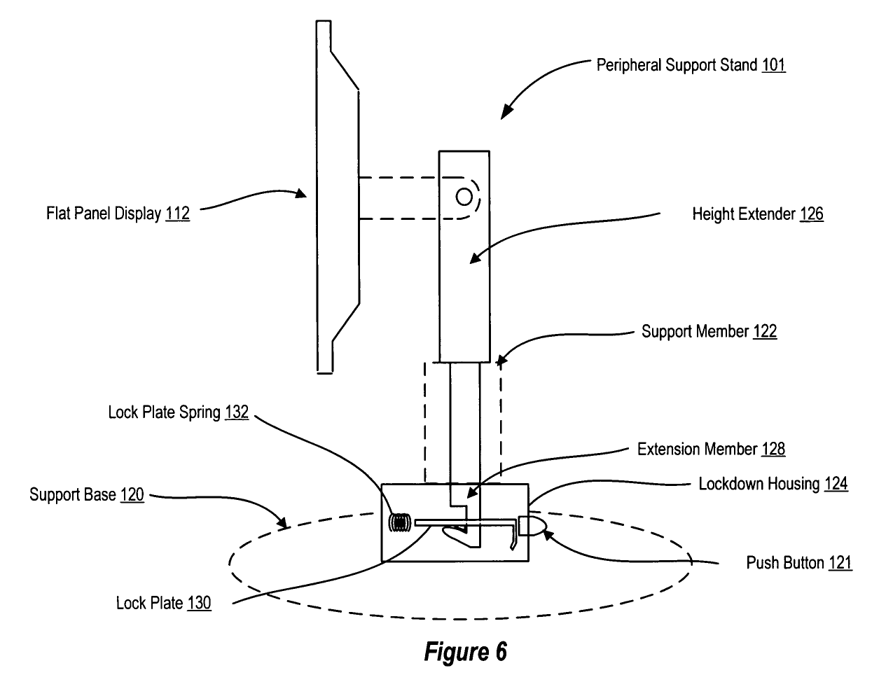

While the lockdown mechanism embodiments of the present invention may be implemented in a variety of ways with a variety of peripheral support stands, FIG. 6 depicts an exemplary implementation of a lockdown mechanism in a flat panel display system. As depicted, the peripheral support stand 101 supports a flat panel display 112, such as a LCD monitor. The height of the display 112 may be adjusted by the telescoping action of the height extender 126 within the support member 122. The lockdown functionality is provided by releasable engagement of the lock plate 130 with the extension member 128 which is affixed to the height extender 126. As described herein, the extension member 128 is engaged with the lock plate 130 by actuating push button 121 to align a slot (not shown) in the lock plate 130 so that the extension member 128 may pass trough the slot. When the push button 121 is deactuated, the lock plate spring 132 pushes the lock plate 130 back to its normal or preferred position in the lockdown housing 124, thereby holding the extension member 124 in a locked position. To release the extension member 128, the push button 121 is actuated while the height extender 126 is pushed down, thereby disengaging the extension member 128 for vertical upward movement so that the display 112 may be raised.

While the system and method of the present invention has been described in connection with the preferred embodiment, it is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

1. A peripheral support stand comprising:
a height adjustable stand operable to mount a peripheral device in a vertically raised position and to support movement of the peripheral device in variable positions; and
a locking mechanism for releasably engaging the height adjustable stand in a full-down position.

2. The peripheral support stand of claim 1, further comprising a detachment device for attaching a peripheral device to the height adjustable stand and for detaching the peripheral device upon actuation of a push button.

3. The peripheral support stand of claim 1 wherein the peripheral device comprises flat panel display monitor.

4. The peripheral support stand of claim 1 wherein the locking mechanism comprises an actuator for unlocking the locking mechanism to permit movement of the height adjustable stand.

5. The peripheral support stand of claim 4 wherein the actuator comprises a push button.

6. The peripheral support stand of claim 1 wherein the locking mechanism comprises a sliding locking plate having at least one slot, said sliding locking plate being positioned to engage with an extension member in the height adjustable stand when the height adjustable stand is in a full-down position.

7. The peripheral support stand of claim 6, further comprising an actuator for disengaging the extension member from the locking plate.

8. The peripheral support stand of claim 1 wherein the locking mechanism comprises a slideably engaged lock piece having at least one engagement tab for releasably engaging with an extension member in the height adjustable stand when the height adjustable stand is in a full-down position.

9. The peripheral support stand of claim 8 further comprising an actuator for disengaging the slideably engaged lock piece from the extension member.

10. The peripheral support stand of claim 9, where the actuator comprises a push button.

11. The peripheral support stand of claim 9, where the actuator comprises a spring for maintaining the slideably engaged lock piece in a first position and a push button for moving the slideably engaged lock piece into a second position.

12. A support stand for a detachable peripheral device comprising:
a support stand operable to rest on a surface;
an attachment plate operably connected to the support stand;
a releasable connector affixed to the peripheral device, said connector comprising a movable latch for releasably engaging with the attachment plate and an actuator for disengaging the movable latch from the attachment plate.

13. The support stand of claim 12 wherein the peripheral device comprises flat panel display monitor.

14. The support stand of claim 12 wherein the attachment plate comprises one or more tabs for engagement with the movable latch.

15. The support stand of claim 12 wherein the attachment plate comprises a plurality of mounting holes that comply with a VESA standard for hole patterns.

16. The support stand of claim 12 where the support stand comprises a height adjustable support stand comprising a lockdown device for releasably engaging the height adjustable support stand in a full-down position.

17. The support stand of claim 12 wherein the actuator comprises a push button.

18. The support stand of claim 12 wherein the movable latch comprises die cast metal.

19. The support stand of claim 12 where the movable latch comprises at least one engagement tab and a first slanted surface, and where actuator comprises a push button and a second slanted surface, said movable latch and said actuator being operably coupled so that the first slanted surface engages with the second slanted surface to move the movable latch when the actuator is actuated.

20. The support stand of claim 12 where the releasable connector comprises guide sleeves in which is positioned the movable latch for slidable engagement.
